(19) United States
(12) Patent Application Publication
(10) Pub. No.: US 2023/0195955 A1
(43) Pub. Date: Jun. 22, 2023

(54) COMPUTER-IMPLEMENTED METHOD FOR CREATING A THREE-DIMENSIONAL SIMULATION ENVIRONMENT

(71) Applicant: dSPACE GmbH, Paderborn (DE)

(72) Inventors: Kira WITTENBORN, Paderborn (DE); Philipp ATORF, Paderborn (DE)

(73) Assignee: dSPACE GmbH, Paderborn (DE)

(21) Appl. No.: 18/084,640

(22) Filed: Dec. 20, 2022

(30) Foreign Application Priority Data
Dec. 21, 2021 (EP) 21216228

(51) Int. Cl. G06F 30/13; G06F 30/20; G06F 18/20; B60W 50/06; B60W 50/02

(52) U.S. Cl. CPC G06F 30/13; G06F 30/20; G06F 18/29; B60W 50/06; B60W 50/0205; G06F 2111/20

(57) ABSTRACT

A method for creating a three-dimensional simulation environment, including: providing a basic library containing three-dimensional virtual objects; detecting the input of a geographic region; obtaining characteristic information, which characterizes the features of different areas; deriving additional information for the various areas of the geographic region on the basis of the characteristic information, land use information being derived as additional information if the characteristic information does not comprise any land use information; ascertaining the objects from the basic library which occur in the geographic region, and storing these objects in a regional library; dividing the geographic region into sectors of the same land use on the basis of the land use information; ascertaining, for each sector, the objects from the regional library which match the land use of this sector; and filling each sector with a selection of objects, based on its land use.

This nonprovisional application claims priority under 35 U.S.C. § 119(a) to European Patent Application No. EP 21216228, which was filed in Europe on Dec. 21, 2021, and which is herein incorporated by reference.

### BACKGROUND OF THE INVENTION

### Field of the Invention

The present invention relates to a computer-implemented method for creating a three-dimensional (3D) simulation environment.

### Description of the Background Art

The invention is relevant for the technical field of developing and testing driver assistance systems for the autonomous or semi-autonomous driving of a motor vehicle. A motor vehicle that is suitable for autonomous or semi-autonomous driving generally includes a sensor system for detecting objects in the surroundings of the vehicle and is at least partially controlled on the basis of control signals of the sensor system. Corresponding sensors of such a sensor system of the motor vehicle are generally ultrasonic sensors, LIDAR sensors, radar sensors, and/or cameras, with the aid of which the surroundings of the vehicle are detected to thereby achieve an autonomous or at least semi-autonomous driving of the test vehicle. Corresponding sensors are also systems for receiving data from other vehicles or stationary devices of the road traffic to achieve an autonomous or at least semi-autonomous driving of the vehicle by evaluating the data (car2× communication).

In the case of an autonomous driving, the driver no longer has to intervene in the driving process at all, at least over long distances. In the case of semi-autonomous driving, the vehicle automatically reacts to certain traffic situations, i.e., without the intervention of the driver, and thus, for example, avoids a collision with a preceding vehicle traveling more slowly, in that a braking action is automatically initiated upon approaching this preceding vehicle. To be able to carry out automated driving maneuvers of this type, the place in the surroundings of the vehicle where other vehicles, pedestrians, or other obstacles are located is detected with the aid of the sensors of the sensor system.

Before a vehicle equipped with a corresponding sensor system may be operated in practice, i.e., on the real road network, by semi-autonomous or autonomous driving, a multiplicity of tests must be carried out to ensure that the semi-autonomous or autonomous driving is, in fact, reliable and safe. Tests of this type typically take place at an advanced stage, even on public roads using real vehicles. However, tests in the form of simulations are generally carried out ahead of time, using a virtual vehicle which moves in a virtual three-dimensional simulation environment. To test the response of the sensor system for a large number of different, even unforeseen, situations, it is known in the prior art to randomize tests of this type and carry them out as realistically as possible. This also includes testing the motor vehicle, including its sensor system, in very different surroundings. While real vehicles are tested during real tests, for example, in extremely hot desert regions or in extremely cold regions with snow and permafrost, during the tests in the form of simulations, at least the surroundings should correspond to the region of the earth where the test is being carried out.

In conventional situations, this is done in that corresponding virtual environments are programmed “by hand.” However, this approach is extremely complex; after all it involves generating realistic 3D landscapes and 3D scenes having an inadequate data basis. Namely, necessary data are generally missing, or data of this type may at least not be obtained automatically. The creation of complex 3D scenes therefore requires a great deal of manual work. This also includes researching what a region typically looks like. Up to now, this has been done by means of human creativity when manually generating 3D scenes.

### SUMMARY OF THE INVENTION

It is therefore an object of the present invention to easily and reliably create a realistic, virtual three-dimensional environment.

According to an exemplary embodiment of the invention, a computer-implemented method is thus provided for creating a three-dimensional simulation environment, including the following method steps: providing a basic library containing three-dimensional virtual objects; detecting the input of a geographic region, for which the three-dimensional simulation environment is to be created; obtaining of characteristic information which characterizes the features of different areas of the geographic region or the entire geographic region; deriving additional information for the various areas of the geographic region or for the entire geographic region on the basis of the characteristic information, land use information being also derived in any case as additional information if the characteristic information does not comprise any land use information; ascertaining the three-dimensional virtual objects from the basic library which occur in the geographic region, on the basis of the characteristic information and/or the additional information, and storing these three-dimensional virtual objects in a regional library; dividing the geographic region into sectors of the same land use on the basis of the land use information; ascertaining, for each sector, the three-dimensional virtual objects from the regional library, which match the land use of this sector; and filling each sector with a selection of three-dimensional virtual objects, which were ascertained for the particular sector based on its land use.

The term “additional information” can represent information which may not be taken directly from the characteristic information but which may be derived therefrom. For example, the fauna present in the region may be inferred with the aid of the climate zone thereof, so that suitable three-dimensional virtual objects representing the plants may be selected based on its appearance. The characteristic information preferably comprises cadastral information. Cadastral information is information which comes from a cadaster. The term “cadaster” is understood in the present case to be a register, a list, or a collection of information having a spatial reference. In the narrower sense, a cadaster represents, in particular, a real estate cadaster for a register of all land parcels and their description, which covers an entire region. The land parcels, including their spatial location, type of use, and geometry as well as additionally the buildings situated on the land parcels, are preferably described in a descriptive part of the cadaster and in maps of the cadaster.

The invention is a method for automatically creating a realistic virtual 3D environment. It provides that a geographic region is to be reproduced virtually, and a time of year is to be indicated. To do this, the approach may be taken that publicly accessible cadastral information of the geographic environment is initially procured for the purpose of obtaining land use data therefrom. If these land use data are not directly contained in the cadastral information, an attempt is made to derive them logically from the existing data. For example, a region having a very high population density is probably a residential area filled with high-rise buildings, and a densely developed, low-population area is probably an industrial area. One refinement of the invention comprises a pattern recognition for the purpose of deriving a land use from the aerial view of the road network and the developed area. Based on the ultimately available data, the geographic environment may be divided, for example, into land use planning fields, and each planning field may be randomly filled with 3D objects which match the geographic region, time of year, and land use. It is extremely important that, in areas where no or insufficient data are available, the creation of a realistic simulation environment is improved or even made possible at all by adding derived data.

The characteristic information can comprise at least land use information and/or climate information and/or information on the size of the population. If is furthermore preferred that the land use information comprises information on whether an area of the region corresponds to a residential area, an industrial area, an agricultural area, or a nature area. It is also possible, for example, to further divide the “nature area” into “forest,” “mountains,” “steppe,” “desert,” etc., and this information may be further specified, for example, as “mixed woodland,”, “coniferous forest,” “deciduous forest,” etc.

An essential aspect of the invention is also that the three-dimensional simulation environment is represented realistically, depending on the different times of year. For this purpose, it is provided according to a preferred refinement of the invention that at least a portion of the three-dimensional virtual objects of the basic library are parameterizable with respect to their appearance at different times of year, the method including the following additional method steps: detecting the input of a time of year, for which the three-dimensional simulation environment is to be generated; and parameterizing the three-dimensional virtual objects, with which each sector has been filled, with respect to their appearance depending on the entered time of year.

Because the objects are parameterizable, they may thus be adapted with respect to their appearance in such a way that they correspond to the particular time of year.

It is also provided that at least a portion of the three-dimensional virtual objects of the basic library are stored in different versions, these different versions varying with respect to their appearance at different times of year, the method including the following additional method steps: detecting the input of a time of year, for which the three-dimensional simulation environment is to be generated, and in the step of ascertaining the three dimensional virtual objects for each sector from the regional library which are assigned to the land use of this sector, a version of this type is selected for the particular object corresponding to the detected time of year with respect to the objects for one different versions are stored.

According to this example, different versions of the objects which each match a predetermined time of year are thus stored instead of a parameterizability of the objects.

With regard to the characteristic information, the characteristic information preferably comprises information on population density, or the information on population density is derived from the characteristic information, and in the step of deriving additional information from the information on population density, at least a portion of the land use information is inferred. For example, the calculation of the population density from the land area and number of inhabitants, to thereby infer the type of development, i.e., whether the development is made up of high-rise buildings, houses, a housing complex, etc.

The characteristic information can comprise a map, which indicates roads and building outlines, and in the step of deriving additional information, at least a portion of the land use information is inferred with the aid of a pattern recognition applied to the roads and building contours contained in the map.

The characteristic information may also comprise a creation date of a unit situated in the region, and in the step of deriving additional information, if at least a portion of the land use information is inferred from the creation date. A facility may be a building, a square, a park, a planting, etc.

The invention further relates to a nonvolatile, computer-readable memory medium with a three-dimensional simulation environment stored thereon, which was obtained using a method according to one of the preceding claims.

The invention also relates to a method for generating test data for testing a control system which evaluates a sensor data stream, including the following method steps: driving through least a part of the three-dimensional simulation environment stored on the nonvolatile, computer-readable memory medium described above, using a virtual vehicle carrying a virtual sensor; and generating synthetic sensor data with the aid of the sensor, which correspond to data which would have been generated by a real sensor while driving through real surroundings corresponding to the stored three-dimensional simulation environment.

The invention also relates to a nonvolatile, computer-readable memory medium with synthetic sensor data stored thereon, which were obtained with the aid of the method described above.

Further, the invention also relates to a use of the synthetic sensor data stored on the nonvolatile, computer-readable memory medium described above for testing a control system which evaluates a sensor data stream. It is preferably provided that the control system which evaluates a sensor data stream is a driver assistance system for a motor vehicle.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a method for creating a 3D simulation environment according to an example of the invention; and

FIG. 2 schematically shows a method for generating test data for testing a control system which evaluates a sensor data stream according to an example of the invention.

### DETAILED DESCRIPTION

As addressed above, the invention deals with the creation of realistic 3D landscapes and 3D scenes, hereinafter always referred to as a three-dimensional simulation environment, which have an insufficient data basis, since necessary data are missing or may not be obtained automatically. In areas in which no or insufficient data are present, the simulation of the three-dimensional simulation environment is to be improved or even made possible at all by adding other data and ascertaining meta data.

In summary, according to an example of the invention, freely accessible data sets are added. These include geographic data sets such as “land use” (Corine Landcover Dataset 2018), climate zone data, and population data (e.g., from Wikipedia). Other necessary data may then be derived from these data. For example, the fauna may be inferred with the aid of the climate zone, and suitable trees may thus be ascertained for the “mixed woodland” land use class. Another example is the calculation of the population density from the land area and number of inhabitants to thereby determine the type of development (high-rise buildings, housing complex, etc.).

A user can provide the parameters of “geographic region” and “time of year,” i.e., he/she specifies which region of the earth he/she wishes to be mapped as a 3D model at which time of year. The parameters of “geographic region” and “time of year” are detected so that the computer-implemented method may then run fully automatically until the desired three-dimensional simulation environment is fully created.

For example, the type of plants which can occur in the 3D environment may be derived directly from the climate zone. An initial attempt is made to extract as much explicit information as possible from a database or from multiple databases, which contain the characteristic information, which characterizes features of different areas of the geographic region or the entire geographic region.

For example, OpenStreetMap (OSM) may be considered as a database of this type. OSM is a free project which collects and structures freely usable geographic data and stores them in a database for use by anyone (open data). These data are covered by a free license, the Open Database License. The core of the project is therefore an openly accessible database of all contributed geographic information. Maps may generally be created from these data, and the data may also be used for applications such as the present one.

The German Authoritative Real Estate Cadastral Information System (ALKIS) is another database which can be considered in this case. All data of the real estate cadaster are combined for ALKIS. This is a standard nation-wide process and is formulated, together with the Authoritative Topographic-Cartographic Information System (ATKIS) and the Authoritative Fixed Point Information System (AFIS) in the AAA model and is described in GeolnfoDok. ALKIS includes spatially referenced map data and non-spatially reference book data. In this way, a standard basic data pool is also available for the present method, which has been defined as minimum content at the interstate level. Databases such as ALKIS are also available for many other countries outside Germany.

Wikipedia is another database which may also be used in the present case to obtain characteristic information which characterizes the features of different areas of the geographic region or the entire geographic region. For example, Wikipedia is suitable for providing climate data and population data.

To create the simulation environment, necessary information which is not present in databases of this type is derived with the aid of available characteristic information which characterizes the features of different areas of the geographic region or the entire geographic region. Derived information of this type is also referred to as meta data in the present case. This makes it possible to ascertain, for a particular area, for example the type of building that is in all likelihood present there. If an area is identified as a land area used for agricultural purposes, no high-rise buildings and no factory buildings are to be expected there, but rather only single-family homes and agricultural buildings with low population density. The following typical relationships may also be used for ascertaining meta data: A moderate population density indicates a residential area with single-family homes, an extreme population density indicates a residential area with high-rise buildings, a dense development, combined with a low population density, indicates an industrial area or a commercial area, and a low population density indicates a piece of agricultural land or a nature area.

The ascertainment of land use data based on a pattern recognition for the purpose of inferring the use of an area from the topology of the road network and the development. The topology of the road network and the topology of the development are generally available to the public, e.g., from one of the databases mentioned above, and may thus be mapped exactly. According to the exemplary embodiments of the invention described here, information necessary for creating a realistic simulation environment is derived implicitly. This makes it possible to also work with a data basis which does not contain all necessary information directly. As a result, no database therefore needs to be maintained, which contains necessary information for every place on earth or even finished 3D objects.

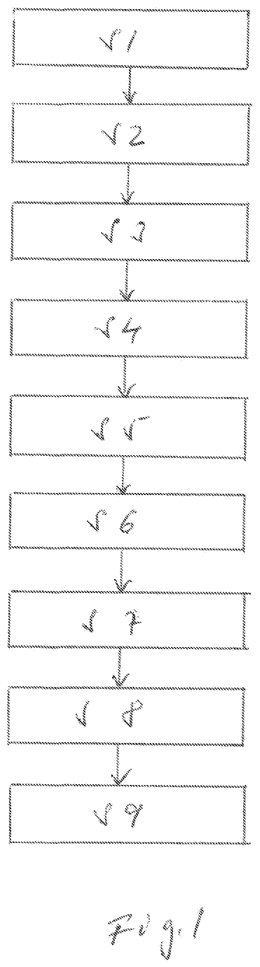

The sequence of the method may be as follows and is illustrated schematically in FIG. 1:

In a first method step S1, a basic library containing three-dimensional virtual objects is provided. These are objects which may generally be used to create the three-dimensional simulation environment. Objects of this type may comprise, in principle, all objects which may appear in the surroundings of a traveling motor vehicle, such as roads, buildings, plants, etc. In the present case, at least a portion of the three-dimensional virtual objects of the basic library are stored in different versions, these different versions varying with respect to their appearance at different times of year.

In step S2, the input of a geographic region is detected, which was entered by a user. This input represents the geographic region for which the three-dimensional simulation environment is to be created. In step S3, the input of a time of year is also detected, for which the three-dimensional simulation environment is to be created. The time of year is also a parameter which was entered by the user. Steps S2 and S3 may also be carried out in combination or at the same time.

An obtaining of characteristic information takes place in step S4, which characterizes the features of different areas of the geographic region or the entire geographic region. In the present case, the characteristic information comprises climate information and information on the size of the population. In this regard, reference is hereby made to the above remarks, in particular with regard to the databases mentioned as examples, OSM, ALKIS, and Wikipedia, which may be used to obtain characteristic information of this type. As also addressed above, this characteristic information generally does not, however, comprise all information needed to create a realistic 3D simulation environment.

In step S5, additional information is therefore derived for the different areas of the geographic region or for the entire geographic region on the basis of the characteristic information. It is essential that, in any case, land use information is also derived as additional information if, as in the present case, the characteristic information does not comprise any land use information.

However, if the characteristic information does already comprise land use information to the extent necessary to be able to create the 3D simulation environment, this information may, of course, be used directly. However, if the land use information does not comprise information on whether an area of the region corresponds to a residential area, an industrial area, an agricultural area, or a nature area, this information may, as described above, be derived as meta data, for example taking the population density into account. In the present case, the characteristic information thus comprises information on the population density, and in the step of deriving additional information from the information on the population density, at least a portion of the land use information is inferred.

In step S6, the three-dimensional virtual objects which occur in the geographic region are ascertained from the basic library on the basis of the characteristic information and the additional information, and these three-dimensional virtual objects are stored in a regional library. In other words, the three-dimensional objects are selected hereby from the original library, which generally match the entered geographic region for which the 3D simulation environment is to be created.

With the aid of the land use information, a division of the geographic region into sectors of the same land use takes place in step S7, and, for each sector, an ascertainment of the three-dimensional virtual objects which match the land use of these sectors takes place from the regional library in step S8. With regard to the objects for which different versions for different times of year are stored in each case, a version of this type is selected in step S8 for the particular sector which corresponds to the detected time of year. In this way, not only the correct three-dimensional objects for the corresponding geographic region are selected for the particular area, namely a particular sector having the same land use, but the objects are also determined therefrom, which also in all probability occur in the particular area at the predetermined time of year.

In step S9, each sector is then filled with a selection of three-dimensional virtual objects, which were ascertained for the particular sector, based on its land use. This concludes the creation of the method for creating a three-dimensional simulation environment. This three-dimensional simulation environment may be used below to generate test data for testing a control system which evaluates a sensor data stream.

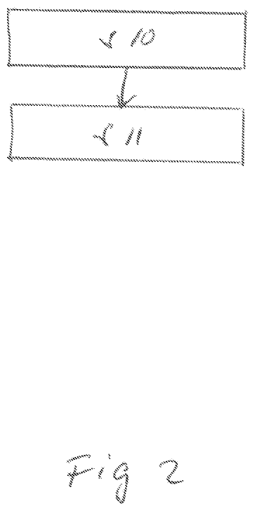

A computer-implemented method illustrated schematically in FIG. 2 may be used for this purpose, which includes the following method steps: a simulated travel through at least a part of a three-dimensional simulation environment, using a virtual vehicle carrying a virtual sensor, in step S10, and a generation of synthetic sensor data with the aid of the sensor, which correspond to data which a real sensor would have generated while driving through real surroundings corresponding to the stored three-dimensional simulation environment, in step S11. The synthetic sensor data obtained in this way may then be used to test a control system which evaluates a sensor data stream.

At this point, it should be noted that, to take into account a particular time of year, it is not absolutely necessary that at least a portion of the objects be stored in different versions with respect to their appearance at different times of year. It is alternatively possible that three-dimensional virtual objects of the basic library are parameterizable with respect to their appearance at different times of year, so that they may be adapted to the particular time of year in this way.

In the event that the characteristic information comprises a map which indicates roads and building contours, at least a portion of the land use information is furthermore inferred in the present case with the aid of a pattern recognition applied to the roads and building contours contained in the map in the step of deriving additional information. This improves the reliability of the ascertainment of the land use information, which results in an even more realistic representation of the 3D simulation environment. If the characteristic information furthermore comprises a creation date of a unit situated in the region, at least a portion of the land use information is inferred in the present case from the creation date in the step of deriving additional information. A specific example here is the date at which trees had been planted. The age of the planting may be used to infer the size of the trees to be represented as three-dimensional virtual objects.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for creating a three-dimensional simulation environment, the method comprising:
providing a basic library containing three-dimensional virtual objects;
detecting the input of a geographic region, for which the three-dimensional simulation environment is to be created;
obtaining characteristic information which characterizes the features of different areas of the geographic region or the entire geographic region;
deriving additional information for the various areas of the geographic region or for the entire geographic region on the basis of the characteristic information, land use information being derived in any case as additional information if the characteristic information does not comprise any land use information;
ascertaining the three-dimensional virtual objects from the basic library which occur in the geographic region, on the basis of the characteristic information and/or the additional information, and storing these three-dimensional virtual objects in a regional library;
dividing the geographic region into sectors of the same land use on the basis of the land use information;
ascertaining, for each sector, the three-dimensional virtual objects from the regional library which match the land use of this sector; and
filling each sector with a selection of three-dimensional virtual objects, which were ascertained for the particular sector, based on its land use.

2. The computer-implemented method according to claim 1, wherein the characteristic information comprises at least land use information and/or climate information and/or information on the size of the population.

3. The computer-implemented method according to claim 1, wherein the land use information comprises information on whether an area of the region corresponds to a residential area, an industrial area, an agricultural area, or a nature area.

4. The computer-implemented method according to claim 1, wherein at least a portion of the three-dimensional virtual objects of the basic library are parameterizable with respect to their appearance at different times of year, the method further comprising:
detecting the input of a time of year, for which the three-dimensional simulation environment is to be generated; and
parameterizing the three-dimensional virtual objects, with which each sector has been filled, with respect to their appearance depending on the entered time of year.

5. The computer-implemented method according to claim 1, wherein at least a portion of the three-dimensional virtual objects of the basic library are stored in different versions, these different versions varying with respect to their appearance at different times of year, the method further comprising:
detecting the input of a time of year, for which the three-dimensional simulation environment is to be generated, and in the step of ascertaining the three dimensional virtual objects, for each sector from the regional library which are assigned to the land use of this sector, a version is selected for the particular sector corresponding to the detected time of year with respect to the objects for which different versions are stored.

6. The computer-implemented method according to claim 1, wherein the characteristic information comprises information on the population density, or the information in the population density is derivable from the characteristic information, and at least a portion of the land use information is inferred from the information on the population density in the step of deriving additional information.

7. The computer-implemented method according to claim 1, wherein the characteristic information comprises a map, which indicates roads and building contours, and in the step of deriving additional information, at least a portion of the land use information is inferred with the aid of a pattern recognition applied to the streets and building contours contained in the map.

8. The computer-implemented method according to claim 1, wherein the characteristic information comprises a creation date of a unit situated in the region, and at least a portion of the land use information is inferred from the creation date in the step of deriving additional information.

9. A nonvolatile, computer-readable memory medium with a three-dimensional simulation environment stored thereon, which was obtained using the method according to claim 1.

10. A computer-implemented method for generating test data for testing a control system which evaluates a sensor data stream, the method comprising:
driving through at least a part of the three-dimensional simulation environment stored on the nonvolatile, computer-readable memory medium according to claim 9, using a virtual vehicle carrying a virtual sensor; and
generating synthetic sensor data with the aid of the sensor, which correspond to data which would have been generated by a real sensor while driving through real surroundings corresponding to the stored three-dimensional simulation environment.

11. A nonvolatile, computer-readable memory medium with synthetic sensor data stored thereon, which were obtained via the method according to claim 10.

12. The nonvolatile, computer-readable memory medium according to claim 11, wherein the synthetic sensor data stored is for testing a control system which evaluates a sensor data stream.

13. The nonvolatile, computer-readable memory medium according to claim 12, wherein the control system which evaluates a sensor data stream is a driver assistance system for a motor vehicle.
